(19) United States
(12) Patent Application Publication
(10) Pub. No.: US 2010/0170937 A1
(43) Pub. Date: Jul. 8, 2010

(54) System and Method of Joining Metallic Parts Using Cold Spray Technique

(75) Inventor: Eklavya Calla, Bangalore (IN)

Correspondence Address: GE Energy-Global Patent Operation;Fletcher Yoder PC, P.O. Box 692289, Houston, TX, 77269-2289, US

(73) Assignee: General Electric Company, Schenectady, NY (US)

(21) Appl. No.: 12/350,091

(22) Filed: Jan. 7, 2009

(51) Int. Cl. B23K 31/02; B32B 37/00; B23K 3/00; B23K 20/24

(52) U.S. Cl. 228/165; 156/60; 228/203; 228/18

(57) ABSTRACT

Systems and methods are disclosed for joining two or more parts together via cold spraying. In one embodiment, a first part and second part may be aligned together to create a joint. The parts are joined by cold spraying a material on the first metal part and the second metal part to create a bond at the joint. A system is disclosed that includes a controller configured to control a cold spray gun to create a bond between a first metal part and second metal part

### BACKGROUND OF THE INVENTION

The subject matter disclosed herein relates generally to the joining of parts, and more particularly to the joining of metals.

In manufacturing, repair, and other processes, parts are joined together to form larger components and structures. A variety of techniques have developed to join metal parts. Welding is a typical technique used to join two or more metal parts together. Although welding has developed into a variety of different types and techniques, conventional joining techniques like welding include some disadvantages. For example, welding two metal parts together may introduce problems in the quality of the materials and joint, control of the welding process, and the application of the welding process. Further, welding may not be suited to joining two dissimilar metals together. Additionally, some types of metal parts, such as forged or cast parts, may not be suitable for welding.

### BRIEF DESCRIPTION OF THE INVENTION

In one embodiment, a method includes aligning a first metal part and a second metal part to create a joint and cold spraying a material on the first metal part and the second metal part to create a bond at the joint.

In another embodiment, a system includes a controller configured to control a cold spray gun to create a bond between a first metal part and second metal part.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a cold spray system for joining parts in accordance with an embodiment of the present invention;

FIG. 2 is a cross-section of a cold spray gun of the system of FIG. 1 in accordance with an embodiment of the present invention;

FIG. 3 is a diagram that depicts a process for joining two parts via a cold spray application in accordance with an embodiment of the present invention;

FIG. 4 is a diagram that depicts a process for joining two parts via a cold spray application in accordance with another embodiment of the present invention; and

FIG. 5 is a diagram that depicts a process for selecting parameters of a cold spray application process for joining two parts in accordance with another embodiment of the present invention.

FIG. 6 is a block diagram of a turbine system having components manufactured in accordance with an embodiment of the present technique;

FIG. 7 is a cutaway side view of an embodiment of the turbine system, as shown in FIG. 6;

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

As discussed further below, embodiments of the present invention provide a system and technique for joining metal parts together using cold spray deposition. As used herein, the term “cold spray” (also referred to as “cold gas dynamic spraying”) refers to spraying high velocity particles (of a “feed stock powder”) using a carrier gas and a convergent-divergent type spray gun, without any combustion of the gas such as in welding or some other spraying processes. The particles impact a metal substrate, such as the surface of a metal part, with enough energy to deform the particles and the substrate and create a metal-to-metal bond between the particles and the substrate. In the embodiments described below, a metal part may be joined to another metal part by positioning the surfaces of each part to form the desired joint and cold spraying the parts and joint. After deposition of the cold spray particles, the joined metal parts may be heated to further form a diffusion bond among the particles and the metal parts. In another embodiment, a groove may be formed in one or both of the metal parts at the desired joint so that the particles may be deposited onto the groove via cold spraying. Additionally, controlling the parameters of the cold spray process, the parameters of the particles, and heating the metal parts may allow control of the bond created by the cold spray application.

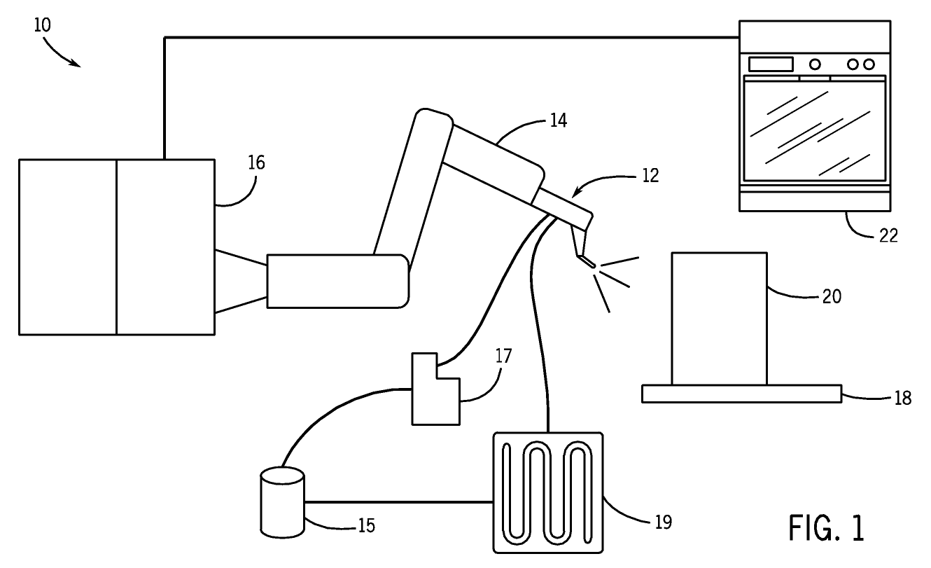

FIG. 1 depicts a system 10 for joining to metals together via a cold spray process in accordance with an embodiment of the present invention. The system may include a cold spray gun 12 coupled to a robotic arm 14, a controller 16, and a work stand 18. The controller 16 may control the robotic arm 14 to control application of the cold spray to one or more metal parts and surfaces. The spray gun 12 may receive gas from a gas source 15, such as pressurized gas canister or a gas supply system. Any type of gas can be used as process gas, however, gases typically utilized are helium, nitrogen, air or mixtures of these gases. The spray gun 12 may also receive feed stock powder from a feeder 17. In some embodiments, gas from the gas source may pass through a heating apparatus 19 before input into the cold spray gun 12. The work stand 18 may include a secure mount or other suitable device for holding one or more metal parts 20 to be worked. The work stand 18 may also include a motor or other suitable device for rotating the metal parts to be joined together. The devices could be CNC controlled for precision and accuracy.

The parts 20 may include any number, type, shape, or size parts. For example, the parts 20 may include gas turbine parts such as rotors, blades, blisks, and/or nozzles. The parts 20 may include metal parts formed by any process, such as machining, forging, welding, and/or casting. Additionally, the parts 20 may include two or parts made of similar metals or two or more parts made of dissimilar metals. In other embodiments, the parts may be made from non-metals e.g. ceramics and polymers. In case of joining non-metals, the heat treatment discussed below may not be omitted.

As described further below, the controller 16 may also monitor and control various parameters of the cold spray process. For example, the parameters may include the duration of the cold spray, the number of applications of the cold spray, the source of the feed stock powder, the temperature of the cold spray process (such as controlled by the temperature of the process gas), mass flow of the process gas, feed rate of the powder feedstock, or any other parameter may be monitored and controlled by the controller 16. The system 10 may also include an oven 22 or other suitable heating apparatus, which may be controlled by the controller 16, to heat the parts 20 after application of the cold spray. In some embodiments, the cold spray gun 12 may be manually operated (e.g., without a robotic arm 14 and/or controller 16) so that an operator may directly operate the gun and spray the parts 20.

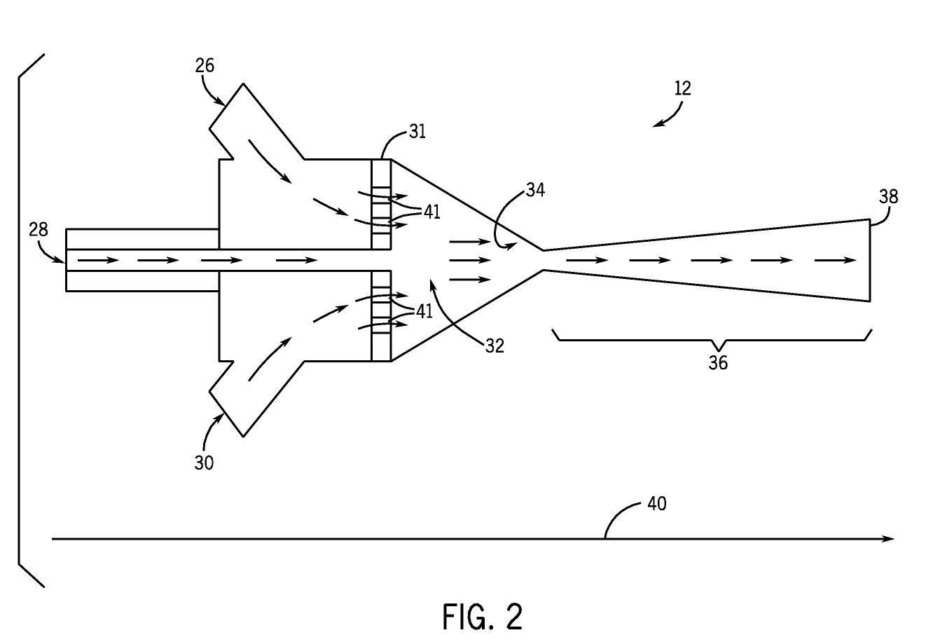

FIG. 2 depicts a cross-section of the cold spray gun 12 in accordance with an embodiment of the present invention. The cold spray gun 12 includes a process gas inlet 26, a feed stock powder inlet 28, temperature and pressure port 30, and a diaphragm 31. The interior of the cold spray gun 12 includes a convergent region 32, a throat 34, a divergent region 36, and an outlet 38. The flow of the cold spray is through the gun is generally indicated by arrow 40. The ratio of cross-section area of the outlet 38 to the cross-section area of the throat 34 along with the type of gas used determines the exit speed, (e.g., exit Mach value) of the process gas. For example, a higher ratio delivers higher gas velocity.

The process gas inlet 26 provides an inlet for the high velocity gas stream that propels the feed stock powder into the gun 12, through ports 41 of the diaphragm 31 into the convergent region 32, through the throat 34 and divergent region 36, and out of the outlet 38. The process gas provided through the inlet 26 is provided at a relatively high pressure, such as from a gas canister, compressor, a gas supply system or a combination thereof. In some embodiments, the process gas may consist essentially of helium, nitrogen, air, or any suitable gas. In some embodiments, depending on the spray parameters the process gas may accelerate the feedstock particles to velocities of 300 m/s to 1200 m/s. Additionally, the process gas may also be heated, as described further below, to about 800° C.

The powder inlet 28 receives a feed stock powder that provides a coating on the substrate of the metals to be sprayed. As used herein, the term feed stock powder may refer to particles of any size, shape, and composition used in the cold spray process. In some embodiments, the particles may range from about 1 micron to about 250 micron, with a size of about 10 micron to about 25 micron used in the embodiment discussed below (e.g, feed stock powder in the feeder 17 may include particles of any size in these ranges). The particles of the feed stock powder may be spherical, non-spherical, or any other shape, or any combination thereof.

The feed stock powder may be any suitable metal or other material to form the desired joint between the parts 20. The feed stock powder may include steel, nickel, aluminum, copper, tungsten, titanium, any other metal, or combination thereof (e.g., alloys, etc.). The feed stock powder may be similar to or dissimilar to the metal of the parts 20 to be joined. Additionally, as described further below, the feed stock powder or the composition thereof may be changed during the cold spray process. For example, the process may provide spray a series of different materials one after another, a plurality of different materials at the same time, or a combination thereof. Further, the divergent region 36 and outlet 38 may be selected to affect the width of the cold spray. For example, the gun 20 can be designed to provide a narrow spray beam or a broad spray beam, depending on the width of the area being sprayed.

The temperature and pressure port 30 may receive sensors configured to provide temperature and pressure measurements of the process gas and feed stock powder in the gun 12 to the controller 26. The controller 16 may adjust parameters of the cold spray process based on the feedback received from the temperature and pressure sensors at the port 30. For example, the controller 16 may adjust a heater output, a valve position, a flow rate of the gas, a flow rate of the powder, or any other parameter.

Inside the gun 12, the feed stock powder is accelerated to very high velocities, such that the powder impacts the part being sprayed to form a metal-to-metal bond. The expansion of the pressurized process gas in the divergent region 36 aids in accelerating the particles to the high velocities. In one embodiment, the particles may reach a velocity of about 300 m/s, 400 m/s, 500 m/s, 600 m/s, 700 m/s, 800 m/s, 900 m/s, 1000 m/s, 1100 m/s, and about 1200 m/s. The convergent region 32, throat 34, and divergent region 36 aid in accelerating the feed stock particles, when combined with the process gas, to the high velocity for the cold spray process. The particles of the feed stock powder are generally accelerated to velocities high enough to reduce the possibility of any in-flight oxidation or other reaction during transfer to the parts being sprayed.

The high velocity impact at the surface of the parts being sprayed breaks up any oxide on the particles and/or the surface of the metal part and deforms the particles, ensuring that particles adhere to the surface of the parts. As a result of rapid cold working upon impact, high strain values are achieved at a high strain rate during cold spraying. The virgin metal-to-metal contact and the high localized temperature at the impact between the particles of the feed stock powder and the metallic surface of the parts being sprayed creates a bond between the particles and the metal parts. The bond is formed by the coating of the particles over the area of parts being sprayed. This coating of particles may be built up be repeating the cold spray process. As described further below, by using a suitable composition of the powder, similar or dissimilar metal parts may be joined though the bond formed by the cold spray coating.

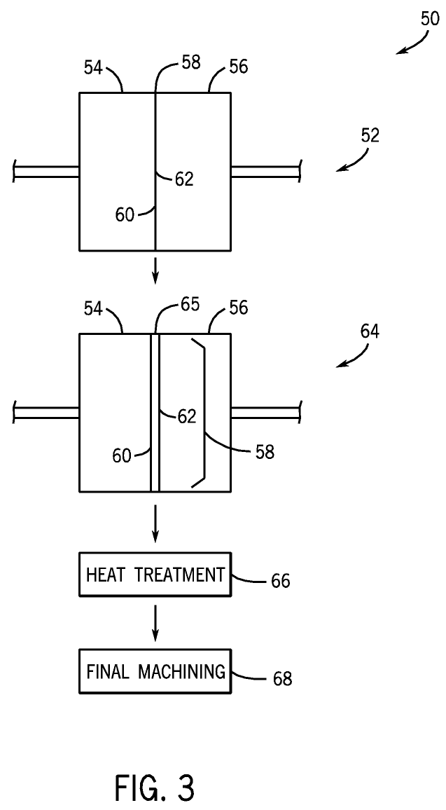

FIG. 3 is a diagram that depicts a process 50 for joining two metal parts using cold spraying in accordance with an embodiment of the present invention. Initially, in step 52, a first part 54 and a second part 56 to be joined may be placed next to each other and aligned in a desired configuration, to create a joint 58. As shown in FIG. 3, the first part 54 includes a surface 60 that will be joined to a surface 62 of the second part 56. Thus, when aligning the parts 54 and 56 next to each other in preparation for joining, the surface 60 of the first part 54 is placed next to the surface 62 of the second part 56. It should be appreciated that the surfaces 60 and 62 may be any size, shape, or topography.

In step 64, the cold spray is applied to the parts 54 and 56 and the joint 58 to deposit particles across the parts 54 and 56 and joint 58. The cold spray provides a cold spray deposition coating 65 along the interface between the surface 60 of the first part 54 and the surface 62 of the second part 56. As described above, the impact of the high velocity cold spray particles creates a metal-to-metal bond between the particles and the parts 54 and 56. The metal-to-metal bond between the particles and the surfaces 60 and 62 joins the two parts 54 and 58 together at the joint 58. Advantageously, the mobility and targeting of the cold spray gun 20 allows for cold spraying on any size, shape, and/or topography of surface 60, surface 62, and joint 58. The width of the coating 5 may be controlled by adjusting the distance of the gun 12 from the joint 58, adjusting the width of the spray from the gun 12, and/or adjusting the velocity of the particles (such as through selection of the process gas). Additionally, the parts 54 and 56 may be aligned in any orientation, e.g., horizontally, vertically, or any angle.

After deposition of the cold spray particles and formation of the particle coating 65, the parts 54 and 56 may be heat-treated (block 66), such as in an oven or other suitable device, to extend the diffusion bond between the cold spray coating 65 and the surfaces 60 and 62, and between the surfaces 60 and 62. The temperature and duration of the heat treatment may be selected depending on the material and to form any depth of diffusion bond. Thus, the diffusion bond created by the cold spray coating 65 may extend to any distance below the surfaces 60 and 62. After heat treatment, the parts may be machined (block 68) to obtain the desired dimensions, shape, and size for the joined parts 54 and 56.

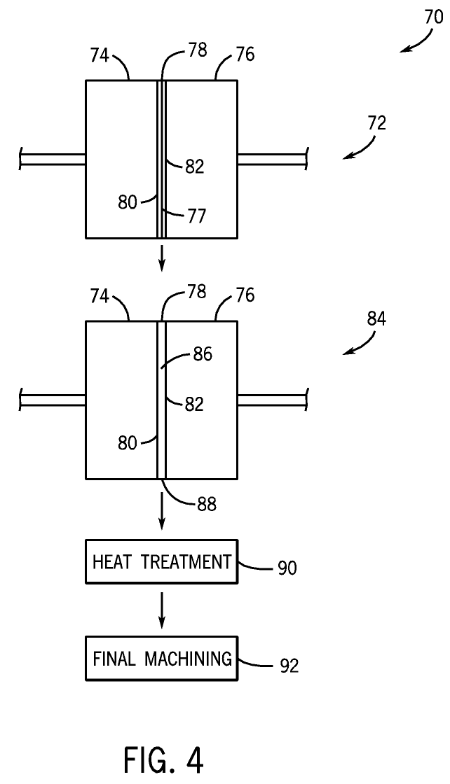

FIG. 4 is a diagram that depicts a process 70 for joining two metal parts using cold spraying in accordance with another embodiment of the present invention. Initially, in step 72, a first part 74 and a second part 76 to be joined may be placed next to each other and aligned in a desired configuration along interface 77. A groove 78 may be formed along interface 77 on the parts 74 and 76, such as by machining or other suitable technique, to provide a recessed region for deposition. The groove creates a recessed surface 80 on the first part 74 and a recessed surface 82 on the second part 76 on opposite sides of interface 77.

In comparison to the embodiment discussed above in FIG. 3, the formation of the groove 78 enables an increased depth of joining between the parts 74 and 76. Additionally, the depth of the groove 78 may be varied to control the depth of the joining. The recessed surface 80 of the first part 74 is joined to the recessed surface 82 of the second part 76 through deposition of the cold spray coating in the groove 78. In some embodiments, the groove 78 may be formed in each part 74 and 76 separately before placing the parts together along interface 77 for joining.

In step 84, after formation of the groove 78, the cold spray particles may be deposited in the groove 78, and to the surfaces 80 and 82, to form a coating 86. Again, as described above, the high velocity particles of the cold spraying creates a metal-to-metal bond between the particles and the surfaces 80 and 82. The deposited coating 86 in the groove 78 bonds the surface 80 of the first part 74 and the surface 82 of the second part 76 to form a joint 88 between the parts 74 and 76. As stated above, the depth of the groove 78 controls the depth of the joint 88 formed by the coating 86. Again, the mobility and targeting of the cold spray gun 20 allows for cold spraying on any size, shape, and/or topography of the surface 80, the surface 82, and the groove 78. For example, the groove 78 may be flat, angled, curved, annular, and/or any combination thereof. For example, the groove 78 may have a V-shape, a U-shape, a rectangular shape, or any other suitable shape. Additionally, the parts 54 and 56 may be aligned in any orientation, e.g., horizontally, vertically, or any angle 74 and 76.

After cold spray deposition of the particles and formation of the coating 86 in the groove 78, the parts 74 and 76 may be heat treated (block 90), such as in an oven or other suitable device. The heat treatment aids in extending a diffusion bond beyond the cold spray coating 86 and the surfaces 80 and 82, and between the surfaces 80 and 82. As mentioned above, the temperature and duration of the heat treatment may be selected depending upon the material and to form any desired depth of the diffusion bond, such as by extending the diffusion bond to any distance beyond the surfaces 80 and 82. After heat treatment, the parts may be machined (block 92) to obtain the desired dimensions, shape, and size for the joined parts 74 and 76.

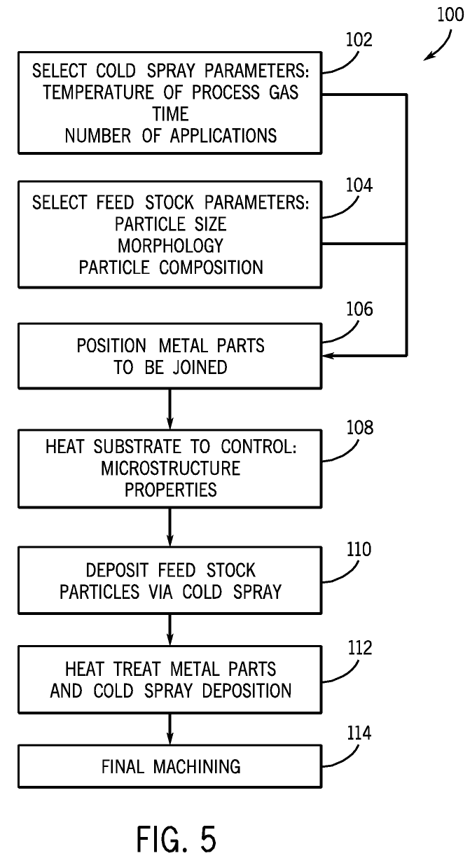

FIG. 5 depicts an embodiment of a process 100 for controlling the joining of two metal parts using cold spraying as described above. For example, the process 100 may be used with the techniques illustrated in FIGS. 3 and 4. The process 100 may include control and selection of parameters based on the metals to be joined and the desired microstructure and properties of the joint. It should be appreciated that any of the parameters and described steps of the process 100 may be omitted or included in any embodiment. Any or all steps of the process 100 may be implemented on a computer, such as by code for executing one or more steps of the process 100 stored on a tangible computer-readable medium.

In block 102, the parameters of the cold spray deposition may be selected. These parameters may include the composition of the process gas, temperature of the process gas, the duration of each application of a coating, and the number of coatings. As described above, the process gas may be helium, nitrogen, air, any suitable gas, or any combination thereof. The temperature of the process gas may be selected to ensure that the particles attain the high velocity to create the metal-to-metal bond upon impact on the metal substrate of the parts. In one embodiment, the process gas may be heated to greater than 400° C., 500° C., 600° C., 700° C., 800° C., etc.

Additionally, the duration of each application of a cold spray coating and the number of coatings may be selected and controlled. The duration of the application of a coating and the number of coatings may affect the thickness of the final coating and, thus, the thickness of the joint between the parts being joined. The thickness of the coating may also affect the duration of heating used to reach specific depth of the diffusion bond. A particular advantage of using cold spraying is that due to the extremely high levels of cold working of the feedstock material and the substrate near the coating, the diffusion rates observed are generally higher that those observed in conventionally prepared materials (like casting, forging etc). Thus, relatively deeper diffusion bonds may be created in relatively shorter heating times.

In block 104, the parameters of the feed stock powder (i.e., the cold spray particles) may be selected. For example, the morphology, size, and composition of the particles may be selected. As mentioned above, the particles may be any size particles, such as nano-sized particles, grain-sized particles, or any suitable size. In some embodiments, the particles may range from about 1 micron to about 250 micron (e.g., the particles in the feed stock powder may be within any size or subset range of the ranges disclosed herein). The composition of the particles may be the same as the parts being joined, or the composition may be different than the parts being joined. Such compositions may include steel, nickel, aluminum, copper, tungsten, titanium, any other metal, or combination thereof (e.g., alloys, etc.). Additionally, the particles may include additional materials, such as carbon, (e.g., carbides). In one embodiment, the particles of the feed stock powder may be steel-nickel. Additionally, in some embodiments, the composition of the particles may be varied over the duration of an application. For example, when joining two dissimilar metal parts, the composition of the particles may be changed as the cold spray deposition is applied from one metal part to the other metal part.

Next, in block 106, the metal parts to be joined may be positioned, as described above in FIGS. 3 and 4. For example, the surfaces of each part that will make up the joint may be positioned adjacent to each other. Further, if a groove is to be formed in the parts, as described in FIG. 4, the parts may be positioned such that groove can be formed at the desired joint.

In some embodiments, the metal parts to be joined may be heated before or during the cold spray deposition. In other embodiments, heating of the metal parts before or during the cold spray deposition may be omitted from the process 100. The heating of the parts to be joined may be used to control the microstructure and properties of the bond formed by the cold spray coating and the parts. For example, in an embodiment of joining a steel alloy part, the heating may be used to alter the grain boundaries of the steel alloy to better prepare the surface of the steel alloy part to form a bond with the particles of the cold spray coating. This microstructure may be further controlled by the duration and temperature of the heating of the parts. In some embodiments, the parts may be heated from about 200° C. to the melting point of the parts being joined.

In block 110, the particles may be applied via the cold spraying to form the coating at the interface of the parts being joined. For example, the cold spray may be applied to the surfaces of the parts to be joined (as described in FIG. 3), or a groove formed in the parts (as described in FIG. 4). Based on the cold spray parameters selected above, the cold spraying may be performed at a specific temperature of the process gas, at a selected duration for each coating, and for a selected number of coatings (as described in block 102). Additionally, the particles used may be based on the selected feed stock parameters (as described in block 104).

After deposition of the cold spray coating, the metal parts and the bond may be heat treated (block 112), such as in an oven or by any other suitable device. In some embodiments, the heat treatment may be performed at temperatures greater than 200° C., 300° C., 400° C., 500° C., 600° C., 700° C., 800° C., 900° C., 1000° C., up to the melting point of the parts to be joined. Further, in some embodiments, selection of certain cold spray parameters may enable minimization or elimination of the heat treatment. For example, at a sufficient process gas temperature, and number of cold spray coatings, the diffusion bond created by the cold spray deposition may be sufficient without further heat treatment. After formation of the bond between the parts, the parts may undergo final machining to reach the desired dimensions, size and shape.

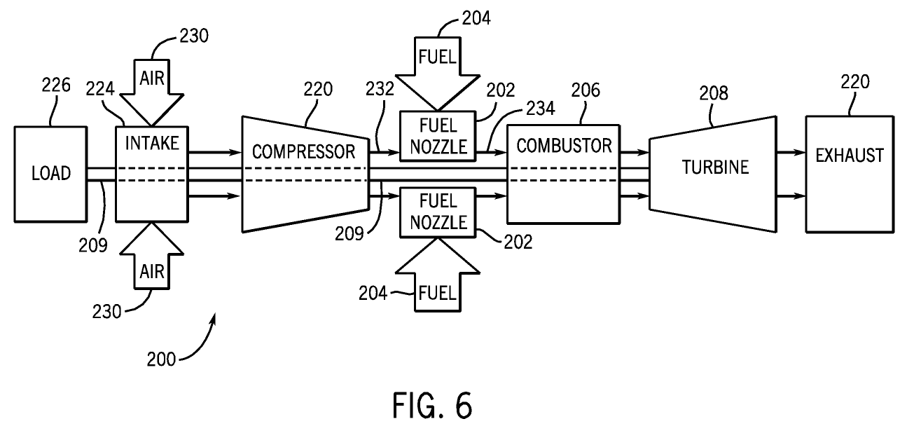

Turning now to the drawings and referring first to FIG. 6, a block diagram of an embodiment of a gas turbine system 200 is illustrated. As discussed in detail above, the disclosed embodiments may be used to joint various metal parts to form the various components in the turbine system 200. The diagram includes fuel nozzle 202, fuel supply 204, and combustor 206. As depicted, fuel supply 204 routes a liquid fuel or gas fuel, such as natural gas, to the turbine system 200 through fuel nozzle 202 into combustor 206. As discussed below, the fuel nozzle 202 is configured to inject and mix the fuel with compressed air with an improved fuel-air mixture. The combustor 206 ignites and combusts the fuel-air mixture, and then passes hot pressurized exhaust gas into a turbine 208. The exhaust gas passes through turbine blades in the turbine 208, thereby driving the turbine 208 to rotate. In turn, the coupling between blades in turbine 208 and shaft 209 will cause the rotation of shaft 209, which is also coupled to several components throughout the turbine system 200, as illustrated. Eventually, the exhaust of the combustion process may exit the turbine system 200 via exhaust outlet 220.

In an embodiment of turbine system 200, compressor vanes or blades are included as components of compressor 222. Blades within compressor 220 may be coupled to shaft 209, and will rotate as shaft 209 is driven to rotate by turbine 208. Compressor 220 may intake air to turbine system 200 via air intake 224. Further, shaft 209 may be coupled to load 226, which may be powered via rotation of shaft 209. As appreciated, load 226 may be any suitable device that may generate power via the rotational output of turbine system 200, such as a power generation plant or an external mechanical load. For example, load 226 may include an electrical generator, a propeller of an airplane, and so forth. Air intake 224 draws air 230 into turbine system 200 via a suitable mechanism, such as a cold air intake, for subsequent mixture of air 230 with fuel supply 204 via fuel nozzle 202. As will be discussed in detail below, air 230 taken in by turbine system 200 may be fed and compressed into pressurized air by rotating blades within compressor 220. The pressurized air may then be fed into fuel nozzle 202, as shown by arrow 232. Fuel nozzle 202 may then mix the pressurized air and fuel, shown by numeral 234, to produce an optimal mix ratio for combustion, e.g., a combustion that causes the fuel to more completely burn, so as not to waste fuel or cause excess emissions. An embodiment of turbine system 200 includes certain structures and components within fuel nozzle 202 to improve the air fuel mixture, thereby increasing performance and reducing emissions.

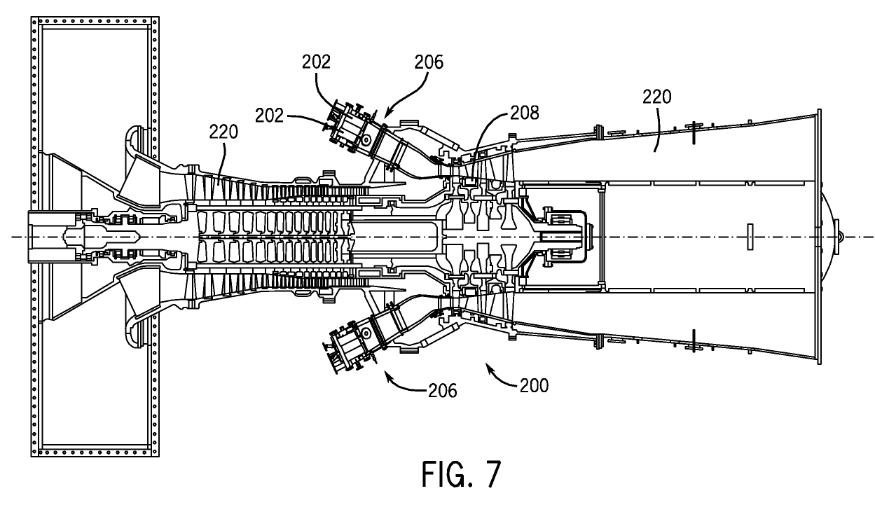

FIG. 7 shows a cutaway side view of an embodiment of turbine system 200. As depicted, the embodiment includes compressor 220, which is coupled to an annular array of combustors 206. For example, six combustors 206 are located in the illustrated turbine system 200. Each combustor 206 includes one or more fuel nozzles 12, which feed an air fuel mixture to a combustion zone located within each combustor 206. For example, each combustor 206 may include one or more fuel nozzles 202 in an annular or other suit arrangement. Combustion of the air fuel mixture within combustors 206 will cause vanes or blades within turbine 208 to rotate as exhaust gas passes toward exhaust outlet 220. As will be discussed in detail below, certain embodiments of fuel nozzle 202 include a variety of unique features to improve the air fuel mixture, thereby improving combustion, reducing undesirable exhaust emissions, and improving fuel consumption.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method, comprising:
aligning a first metal part and a second metal part to create a joint; and
cold spraying a material on the first metal part and the second metal part to create a bond at the joint.

2. The method of claim 1, comprising heating the first metal part, the second metal part, and the joint after cold spraying of the material.

3. The method of claim 1, comprising heating the first metal part, the second metal part, and the joint during cold spraying of the material.

4. The method of claim 1, comprising machining the first metal part, the second metal part, or a combination thereof, after cold spraying of the material.

5. The method of claim 1, wherein cold spraying the material comprises depositing a plurality of layers of different materials one after another.

6. The method of claim 1, wherein the metal of the first metal part is dissimilar to the metal of the second metal part.

7. The method of claim 1, wherein the material comprises the metal of the first part, the metal of the second part, or a combination thereof.

8. The method of claim 1, comprising:
forming a groove in the first metal part, the second metal part, or a combination thereof at the joint; and

9. The method of claim 8, comprising cold spraying the material in the groove.

10. The method of claim 1, comprising heating a process gas of the cold spraying.

11. A system, comprising:
a controller configured to control a cold spray gun to create a bond between a first metal part and second metal part.

12. The system of claim 11, comprising a cold spray gun.

13. The system of claim 12, comprising a robotic arm coupled to the controller and the cold spray gun.

14. The system of claim 11, comprising a gas source.

15. The system of claim 11, comprising a feed stock source.

16. The system of claim 11, comprising a heating apparatus to heat the first metal part and second metal part to diffusion bond the first metal part to the second metal part.

17. The system of claim 12, wherein the controller is configured to control the temperature of a gas flowing through the cold spray gun, a duration of spraying from the cold spray gun and the number of sprayings from the cold spray gun.

18. The system of claim 12, wherein the first metal part, the second metal part, or a combination thereof comprise a rotor, blade, blisk, nozzle, or combination thereof, of a turbine.

19. A method, comprising:
aligning a first non-metal part and a second non-metal part to create a joint; and
cold spraying a material on the first non-metal part and the second non-metal part to create a bond at the joint.

20. The method of claim 19, wherein the first non-metal part consists of a ceramic or a polymer and the second non-metal part consists of a ceramic or a polymer.
